(19) United States
(12) Patent Application Publication
(10) Pub. No.: US 2006/0154847 A1
(43) Pub. Date: Jul. 13, 2006

(54) Soft detergent mixtures

(76) Inventors: Karl Heinz Schmid, Mettmann (DE); Josef Koster, Dusseldorf (DE); Hans-Christian Raths, Monheim (DE); Andreas Subenbach, Solingen (DE); Andreas Syldath, Monheim (DE)

Correspondence Address: COGNIS CORPORATION;PATENT DEPARTMENT, 300 BROOKSIDE AVENUE, AMBLER, PA, 19002, US

(21) Appl. No.: 10/539,729

(22) PCT Filed: Dec. 10, 2003
(86) PCT No.: PCT/EP03/13976

§ 371 Date: Jun. 20, 2005

(30) Foreign Application Priority Data
Dec. 19, 2002 (DE) 102 59 406.6

(51) Int. Cl. C11D 3/37

(52) U.S. Cl. 510/499

(57) ABSTRACT

The invention is a detergent mixture containing: (a) 10% to 30% by weight of protein fatty acid condensate; (b) 1 % to 12% by weight of a protein hydrolyzate; (c) 3% to 20% by weight of an acylated amino acid; (d) 1% to 12% by weight of an amino acid; and (e) 0% to 3% by weight of a preservative. In addition, the composition can optionally contain (f) 0.1% to 10% by weight of a neutralizing agent; (g) 0.1% to 15% by weight of sodium chloride, potassium chloride or mixtures of both; (h) 0.1% to 15% by weight of a solvent; and (i) water. The mixture is a soft detergent suitable for uses which are in contact with the skin, are high foaming and are not affected by hard water.

### FIELD OF THE INVENTION

This invention relates to mild detergent mixtures with improved dermocosmetic compatibility which contain at least one acylated amino acid and a protein fatty acid condensate.

### PRIOR ART

Mixtures of acylated amino acids and protein fatty acid condensates have been known for some time. Thus, DE 10102009 A1 describes surfactant mixtures containing 40 to 80% by weight of an acylated amino acid and 60 to 20% by weight of a protein fatty acid condensate, the quantities mentioned adding up to 100% by weight with water. However, these surfactant mixtures are distinguished by extremely high viscosity and are therefore difficult to handle. In addition, they are sensitive to water hardness.

Accordingly, the problem addressed by the present invention was to provide detergent mixtures based on renewable raw materials which would have a relatively low viscosity and would therefore be easier to handle and unaffected by water hardness. In addition, these detergent mixtures would have at least the same foaming capacity as conventional surfactants, but would be mild to the skin.

### DESCRIPTION OF THE INVENTION

The present invention relates to detergent mixtures containing
(a) 10 to 30% by weight of a protein fatty acid condensate,
(b) 1 to 12% by weight of a protein hydrolyzate,
(c) 3 to 20% by weight of an acylated amino acid,
(d) 1 to 12% by weight of an amino acid and
(e) 0 to 3% by weight of a preservative.

It has surprisingly been found that detergent mixtures with the composition shown above, despite an excellent foaming capacity, are still mild to the skin. At the same time, they are unaffected by water hardness, i.e. water hardness has little influence on their foaming capacity.

In a particularly preferred embodiment, the detergent mixtures according to the invention additionally contain (f) 0.1 to 10% by weight of a neutralizing agent. pH adjustment of the detergent mixture to a value of 6.5 to 8 guarantees minimal coloration and minimal odor because the ingredients of the detergent mixture are optimally stabilized in this pH range. Suitable neutralizing agents are any of the acids typically used in the cosmetic industry which are not irritating to the skin in the concentrations used. Examples of such acids are citric acid, glycolic acid, lactic acid, tartaric acid, glucuronic acid, sulfuric acid and hydrochloric acid.

In addition, the detergent mixtures according to the invention may contain (g) 0.1 to 15% by weight of sodium chloride or potassium chloride or a mixture of sodium and potassium chloride, depending on the alkali used for pH adjustment in the acylation reaction.

Both the physical properties and the performance properties of the detergent mixtures according to the invention can be influenced by the presence of solvents. The detergent mixtures may be adjusted to the required viscosity with the solvent—depending on whether a thickly liquid or thinly liquid product is to be obtained. In addition, the solvents can simultaneously act as moisturizing or conditioning components in cosmetic preparations. In an advantageous embodiment, the detergent mixtures according to the invention contain (g) 0.1 to 15% by weight of a solvent selected from the group consisting of ethanol, isopropanol, 1,2-propylene glycol, trimethyl hexanol, glycerol, ethylene glycol, 2-methylpropane-1,3-diol, 1,3-propylene glycol, dipropylene glycol, 1,3-butylene glycol, butane-1,2-diol, butane-1,4-diol, isopentyl diol, sorbitol, xylitol, mannitol, erythritol, pentaerythritol, 1-methoxy-2-propanol, 2-methoxy ethanol, 2-ethoxy ethanol, 2-propoxy ethanol, 2-isopropoxy ethanol, 2-butoxy ethanol, 1-methoxy-2-propanol, 1-ethoxy-2-propanol, 1-propoxy-2-propanol, 1-isopropoxy-2-propanol, 1-butoxy-2-propanol, 1-isobutoxy-2-propanol, methoxy isopropanol, diethylene glycol monomethyl ether, diethylene glycol monoethyl ether, diethylene glycol monopropyl ether, diethylene glycol monoisopropyl ether, diethylene glycol monobutyl ether, triethylene glycol monomethyl ether, triethylene glycol monoethyl ether, triethylene glycol monopropyl ether, triethylene glycol monoisopropyl ether, triethylene glycol monobutyl ether, dipropylene glycol monomethyl ether, dipropylene glycol monoethyl ether, dipropylene glycol monopropyl ether, dipropylene glycol monoisopropyl ether, dipropylene glycol monobutyl ether, hexylene glycol.

Since the detergent mixture according to the invention contains natural substances which rapidly decompose or are vulnerable to bacterial infestation, it is of advantage to use preservatives. In a preferred embodiment, phenoxyethanol, formaldehyde solution, formaldehyde donors, such as Bronopol or Bronidox, parabens, pentanediol, sorbic acid, salicylic acid or benzoic acid are used.

In addition, components (a) to (d) and (f) of the detergent mixtures according to the invention independently of one another may be present in the form of the alkali metal, alkaline earth metal and/or ammonium salts. In another embodiment, components (a) to (d) and (f) independently of one another are present as ammonium salts, the amines being selected from the group consisting of ammonia, triethanolamine, monoethanolamine, monoisopropanolamine, triisopropylamine, 2-aminobutanol, aminoethyl propanediol. aminomethyl propanol, aminomethyl propanediol and 2-amino-2-hydroxymethyl propane-1,3-diol. In Europe, the surfactants are mainly marketed in the form of their sodium salts whereas, in the USA and South-East Asia, the ammonium salts and particularly the triethanolamine salts are predominant. The reason for this is that, by virtue of their better solubility, the ammonium salts and particularly the triethanolamine salts are high-foaming in cold water (from 10° C.). In Europe by contrast, shampooing and showering are carried out at higher temperatures (30 to 40° C.), so that the sodium salts may also be used.

In a preferred embodiment, the detergent mixtures according to the invention contain 20 to 60% by weight of water. The water content may be adjusted as required, for example depending on whether the detergent is to be compactly transported or to be pump-circulated in thinly liquid form.

In another embodiment, the detergent mixtures according to the invention may also be bleached with 0.1 to 10% by weight of a 50% hydrogen peroxide solution.

The detergent mixtures according to the invention are further distinguished by the fact that the acyl components of the acylamino acid and the protein fatty acid condensate are identical. In a preferred embodiment, the acyl component of the acylamino acid and the protein fatty acid condensate has an alkyl chain length of 8 to 18 carbon atoms. The acyl component may contain 0, 1 or 2 double bonds. Surfactants with excellent cleaning and foaming properties which do not irritate the skin are obtained in particular through acyl components with these chain lengths.

In a particularly preferred embodiment, the acyl component of the acylamino acid and the protein fatty acid condensate is derived from coconut oil fatty acids. It does not matter whether a natural coconut oil cut or a technical mixture with the composition of the coconut oil cut is used. On average, ca. 75% of the coconut oil fatty acids consist of C₁₂₋₁₄ fatty acids and ca. 25% of C₁₆₋₁₈ fatty acids.

According to the invention, glutamic acid, sarcosine, lysine, proline or 4-hydroxyproline is preferred as component (d) or as the amino acid for component (c). These amino acids are distinguished by excellent performance properties both in free and in acylated form. Proline and 4-hydroxyproline in particular are particularly high-foaming in hard water in acylated form.

Wheat or soya protein hydrolyzates, preferably with a molecular weight of 300 to 1,200, or collagen protein hydrolyzates, preferably with a molecular weight of 300 to 1,500, represent the preferred protein hydrolyzate both for component (b) and as the basis of component (a). The protein hydrolyzates and protein fatty acid condensates may be produced by known methods, for example by acidic or enzymatic hydrolysis.

Cosmetic Preparations

The detergent mixtures according to the invention may be used for the production of cosmetic and/or pharmaceutical preparations such as, for example, hair shampoos, hair lotions, foam baths, shower baths, creams, gels, lotions, alcoholic and aqueous/alcoholic solutions, emulsions, wax/fat compounds, stick preparations, powders or ointments. These preparations may also contain other surfactants, oil components, emulsifiers, pearlizing waxes, consistency factors, thickeners, superfatting agents, stabilizers, polymers, silicone compounds, fats, waxes, lecithins, phospholipids, biogenic agents, antioxidants, deodorizers, antidandruff agents, film formers, swelling agents, hydrotropes, solubilizers, perfume oils, dyes and the like as further auxiliaries and additives.

Surfactants/Emulsifiers

The detergent mixtures according to the invention may be combined with surfactants/emulsifiers in the cosmetic and/or pharmaceutical preparations.

Nonionic Surfactants/Emulsifiers

The group of nonionic emulsifiers includes:
(1) products of the addition of 2 to 50 mol ethylene oxide and/or 0 to 20 mol propylene oxide onto linear fatty alcohols containing 8 to 40 carbon atoms, onto fatty acids containing 12 to 40 carbon atoms and onto alkylphenols containing 8 to 15 carbon atoms in the alkyl group;
(2) C_{12/18} fatty acid monoesters and diesters of addition products of 1 to 50 mol ethylene oxide onto glycerol;
(3) glycerol mono- and diesters and sorbitan mono- and diesters of saturated and unsaturated fatty acids containing 6 to 22 carbon atoms and ethylene oxide addition products thereof;
(4) alkyl mono- and oligoglycosides containing 8 to 22 carbon atoms in the alkyl group and ethoxylated analogs thereof;
(5) addition products of 7 to 60 mol ethylene oxide onto castor oil and/or hydrogenated castor oil;
(6) polyol esters and, in particular, polyglycerol esters such as, for example, polyolpoly-12-hydroxystearates, polyglycerol polyricinoleate, polyglycerol diisostearate or polyglycerol dimerate. Mixtures of compounds from several of these classes are also suitable;
(7) addition products of 2 to 15 mol ethylene oxide onto castor oil and/or hydrogenated castor oil;
(8) partial esters based on linear, branched, unsaturated or saturated C₂₋₂₂ fatty acids, ricinoleic acid and 12-hydroxystearic acid and glycerol, polyglycerol, pentaerythritol, dipentaerythritol, sugar alcohols (for example sorbitol), alkyl glucosides (for example methyl glucoside, butyl glucoside, lauryl glucoside) and polyglucosides (for example cellulose) or mixed esters such as, for example, glyceryl stearate citrate and glyceryl stearate lactate;
(9) wool wax alcohols;
(10) polysiloxane/polyalkyl/polyether copolymers and corresponding derivatives;
(11) mixed esters of pentaerythritol, fatty acids, citric acid and fatty alcohol and/or mixed esters of fatty acids containing 6 to 22 carbon atoms, methyl glucose and polyols, preferably glycerol or polyglycerol, and
(12) polyalkylene glycols.

The addition products of ethylene oxide and/or propylene oxide onto fatty alcohols, fatty acids, alkylphenols, glycerol monoesters and diesters and sorbitan monoesters and diesters of fatty acids or onto castor oil are known commercially available products. They are homolog mixtures of which the average degree of alkoxylation corresponds to the ratio between the quantities of ethylene oxide and/or propylene oxide and substrate with which the addition reaction is carried out. Depending on the degree of ethoxylation, these emulsifiers are w/o or o/w emulsifiers. The reaction products with 1 to 100 mol ethylene oxide are particularly suitable.

By virtue of their mildness, the polyolpoly-12-hydroxystearates and mixtures thereof marketed by Cognis Deutschland GmbH, for example under the names of Dehymuls® PGPH (w/o emulsifier) or Eumulgin® VL75 (mixture with Coco Glucosides in a ratio by weight of 1:1; o/w emulsifier) or Dehymuls® SBL (w/o emulsifier), are particularly suitable. The polyol component of these emulsifiers may be derived from substances containing at least 2, preferably 3 to 12 and more particularly 3 to 8 hydroxyl groups and 2 to 12 carbon atoms.

In principle, suitable lipophilic emulsifiers are emulsifiers with an HLB value of 1 to 8 which are listed in numerous Tables and are well-known to the expert. The HLB value for ethoxylated products may also be calculated to the following formula: HLB=(100-L): 5, where L is the percentage by weight of lipophilic groups, i.e. fatty alkyl or fatty acyl groups, in percent by weight in the ethylene oxide adducts.

Of particular advantage from the group of w/o emulsifiers are partial esters of polyols, more particularly C₃₋₆ polyols, such as for example glyceryl monoesters, partial esters of pentaerythritol or sugar esters, for example sucrose distearate, sorbitan monoisostearate, sorbitan sesquiisostearate, sorbitan diisostearate, sorbitan triisostearate, sorbitan monooleate, sorbitan sesquioleate, sorbitan dioleate, sorbitan trioleate, sorbitan monoerucate, sorbitan sesquierucate, sorbitan dierucate, sorbitan trierucate, sorbitan monoricinoleate, sorbitan sesquiricinoleate, sorbitan diricinoleate, sorbitan triricinoleate, sorbitan monohydroxystearate, sorbitan sesquihydroxystearate, sorbitan dihydroxystearate, sorbitan trihydroxystearate, sorbitan monotartrate, sorbitan sesquitartrate, sorbitan ditartrate, sorbitan tritartrate, sorbitan monocitrate, sorbitan sesquicitrate, sorbitan dicitrate, sorbitan tricitrate, sorbitan monomaleate, sorbitan sesquimaleate, sorbitan dimaleate, sorbitan trimaleate and technical mixtures thereof. Addition products of 1 to 30 and preferably 5 to 10 mol ethylene oxide onto the sorbitan esters mentioned are also suitable emulsifiers.

In cases where water-soluble active components and water are incorporated, at least one emulsifier from the group of nonionic o/w emulsifiers (HLB value: 8-18) and/or solubilizers should be used. Such emulsifiers and/or solubilizers are, for example, the ethylene oxide adducts mentioned at the beginning with a correspondingly high degree of ethoxylation, for example 10-20 ethylene oxide units for o/w emulsifiers and 20 to 40 ethylene oxide units for so-called solubilizers. According to the invention, Ceteareth-20 and PEG-20 Glyceryl Stearate are particularly advantageous o/w emulsifiers.

Nonionic emulsifiers from the group of alkyl oligoglycosides are particularly kind to the skin and, accordingly, are particularly suitable as o/w emulsifiers for the purposes of the invention. They enable the sensory properties of the compositions to be optimized. C₈₋₂₂ alkyl mono- and oligoglycosides, their production and their use are known from the prior art. They are produced in particular by reacting glucose or oligosaccharides with primary alcohols containing 8 to 22 carbon atoms, preferably 12 to 22 and more particularly 12 to 18 carbon atoms. So far as the glycoside unit is concerned, both monoglycosides in which a cyclic sugar unit is attached to the fatty alcohol by a glycoside bond and oligomeric glycosides with a degree of oligomerization of preferably up to about 8 are suitable. The degree of oligomerization is a statistical mean value on which the homolog distribution typical of such technical products is based. Products available under the name of Plantacare® contain a C₈₋₁₆ alkyl group attached by a glucosidic bond to an oligoglucoside unit with an average degree of oligomerization of 1 to 2. The acyl glucamides derived from glucamine are also suitable nonionic emulsifiers. The product marketed under the name of Emulgade® PL 68/50 by Cognis Deutschland GmbH, which is a 1:1 mixture of alkyl polyglucosides and fatty alcohols, is preferred for the purposes of the invention. The mixture of Lauryl Glucoside, Polyglyceryl-2-Dipolyhydroxystearate, glycerol and water which is marketed under the name of Eumulgin® VL 75 may also be used with advantage for the purposes of the invention.

The compositions may also contain zwitterionic, amphoteric, cationic and anionic surfactants according to the application envisaged.

Zwitterionic surfactants are surface-active compounds which contain at least one quaternary ammonium group and at least one —COO⁽⁻⁾ or —SO₃⁽⁻⁾ group in the molecule. Particularly suitable zwitterionic surfactants are the so-called betaines, such as the N-alkyl-N,N-dimethyl ammonium glycinates, for example cocoalkyl dimethyl ammonium glycinate, N-acylaminopropyl-N,N-dimethyl ammonium glycinates, for example coco-acylaminopropyl dimethyl ammonium glycinate, and 2-alkyl-3-carboxymethyl-3-hydroxyethyl imidazolines containing 8 to 18 carbon atoms in the alkyl or acyl group and cocoacylaminoethyl hydroxyethyl carboxymethyl glycinate. The fatty acid amide derivative known under the CTFA name of Cocamidopropyl Betaine is a particularly preferred zwitterionic surfactant.

Ampholytic surfactants are also suitable, particularly as co-surfactants. Ampholytic surfactants are surface-active compounds which, in addition to a C_{8/18} alkyl or acyl group, contain at least one free amino group and at least one —COOH— or —SO₃H— group in the molecule and which are capable of forming inner salts. Examples of suitable ampholytic surfactants are N-alkyl glycines, N-alkyl propionic acids, N-alkylaminobutyric acids, N-alkyliminodipropionic acids, N-hydroxyethyl-N-alkylamidopropyl glycines, N-alkyl taurines, N-alkyl sarcosines, 2-alkylaminopropionic acids and alkylaminoacetic acids containing around 8 to 18 carbon atoms in the alkyl group. Particularly preferred ampholytic surfactants are N-cocoalkylaminopropionate and cocoacylaminoethyl aminopropionate.

Anionic surfactants are characterized by a water-solubilizing anionic group such as, for example, a carboxylate, sulfate, sulfonate or phosphate group and a lipophilic group. Dermatologically safe anionic surfactants are known to the expert in large numbers from relevant textbooks and are commercially available. They are, in particular, alkyl sulfates in the form of their alkali metal, ammonium or alkanolammonium salts, alkylether sulfates, alkylether carboxylates, acylisethionates, acyl taurines containing linear C₁₂₋₁₈ alkyl or acyl groups and sulfosuccinates in the form of their alkali metal or ammonium salts.

Particularly suitable cationic surfactants are quaternary ammonium compounds, preferably ammonium halides, more especially chlorides and bromides, such as alkyl trimethyl ammonium chlorides, dialkyl dimethyl ammonium chlorides and trialkyl methyl ammonium chlorides, for example cetyl trimethyl ammonium chloride, stearyl trimethyl ammonium chloride, distearyl dimethyl ammonium chloride, lauryl dimethyl ammonium chloride, lauryl dimethyl benzyl ammonium chloride and tricetyl methyl ammonium chloride. In addition, the readily biodegradable quaternary ester compounds, such as for example the dialkyl ammonium methosulfates and methyl hydroxyalkyl dialkoyloxyalkyl ammonium methosulfates marketed under the name of Stepantex® and the corresponding products of the Dehyquart® series, may be used as cationic surfactants. “Esterquats” are generally understood to be quaternized fatty acid triethanolamine ester salts. They can provide the compositions with particular softness. They are known substances which are prepared by the relevant methods of organic chemistry.

Oil Components

Besides the detergent mixtures according to the invention, the cosmetic and/or pharmaceutical preparations may contain at least one oil component. Suitable oil components are, for example, Guerbet alcohols based on fatty alcohols containing 6 to 18 and preferably 8 to 10 carbon atoms, esters of linear C₆₋₂₂ fatty acids with linear or branched C₆₋₂₂ fatty alcohols, esters of branched C₆₋₁₃ carboxylic acids with linear or branched C₆₋₂₂ fatty alcohols such as, for example, myristyl myristate, myristyl palmitate, myristyl stearate, myristyl isostearate, myristyl oleate, myristyl behenate, myristyl erucate, cetyl myristate, cetyl palmitate, cetyl stearate, cetyl isostearate, cetyl oleate, cetyl behenate, cetyl erucate, stearyl myristate, stearyl palmitate, stearyl stearate, stearyl isostearate, stearyl oleate, stearyl behenate, stearyl erucate, isostearyl myristate, isostearyl palmitate, isostearyl stearate, isostearyl isostearate, isostearyl oleate, isostearyl behenate, isostearyl oleate, oleyl myristate, oleyl palmitate, oleyl stearate, oleyl isostearate, oleyl oleate, oleyl behenate, oleyl erucate, behenyl myristate, behenyl palmitate, behenyl stearate, behenyl isostearate, behenyl oleate, behenyl behenate, behenyl erucate, erucyl myristate, erucyl palmitate, erucyl stearate, erucyl isostearate, erucyl oleate, erucyl behenate and erucyl erucate. Also suitable are esters of linear C₂₋₂₂ fatty acids with branched alcohols, more particularly 2-ethyl hexanol, esters of C₁₈₋₃₈ alkylhydroxycarboxylic acids with linear or branched C₆₋₂₂ fatty alcohols, more especially Dioctyl Malate, esters of linear and/or branched fatty acids with polyhydric alcohols (for example propylene glycol, dimer diol or trimer triol) and/or Guerbet alcohols, triglycerides based on C₆₋₁₀ fatty acids, liquid mono-, di- and triglyceride mixtures based on C₆₋₁₈ fatty acids, esters of C₆₋₂₂ fatty alcohols and/or Guerbet alcohols with aromatic carboxylic acids, more particularly benzoic acid, esters of C₂₋₁₂ dicarboxylic acids with linear or branched alcohols containing 1 to 22 carbon atoms or polyols containing 2 to 10 carbon atoms and 2 to 6 hydroxyl groups, vegetable oils, branched primary alcohols, substituted cyclohexanes, linear and branched C₆₋₂₂ fatty alcohol carbonates such as, for example, Dicaprylyl Carbonate (Cetiol® CC), Guerbet carbonates based on fatty alcohols containing 6 to 18 and preferably 8 to 10 carbon atoms, esters of benzoic acid with linear and/or branched C₂₋₂₂ alcohols (for example Finsolv® TN), linear or branched, symmetrical or nonsymmetrical dialkyl ethers containing 6 to 22 carbon atoms per alkyl group such as, for example, Dicaprylyl Ether (Cetiol® OE), ring opening products of epoxidized fatty acid esters with polyols, silicone oils (cyclomethicone, silicon methicone types, etc.) and/or aliphatic or naphthenic hydrocarbons such as, for example, squalane, squalene or dialkyl cyclohexanes.

Fats and Waxes

Besides oil components, surfactants and emulsifiers and the detergent mixtures according to the invention, the cosmetic and/or pharmaceutical preparations may contain fats and waxes. Typical examples of fats are glycerides, i.e. solid or liquid, vegetable or animal products which consist essentially of mixed glycerol esters of higher fatty acids. Suitable waxes are inter alia natural waxes such as, for example, candelilla wax, carnauba wax, Japan wax, espartograss wax, cork wax, guaruma wax, rice oil wax, sugar cane wax, ouricury wax, montan wax, beeswax, shellac wax, spermaceti, lanolin (wool wax), uropygial fat, ceresine, ozocerite (earth wax), petrolatum, paraffin waxes and microwaxes; chemically modified waxes (hard waxes) such as, for example, montan ester waxes, sasol waxes, hydrogenated jojoba waxes and synthetic waxes such as, for example, polyalkylene waxes and polyethylene glycol waxes. Besides the fats, other suitable additives are fat-like substances, such as lecithins and phospholipids. Lecithins are glycerophospholipids which are formed from fatty acids, glycerol, phosphoric acid and choline by esterification and are also frequently referred to as phosphatidyl cholines (PCs). Examples of natural lecithins are the kephalins which are also known as phosphatidic acids and which are derivatives of 1,2-diacyl-sn-glycerol-3-phosphoric acids. By contrast, phospholipids are generally understood to be mono- and preferably diesters of phosphoric acid with glycerol (glycerophosphates) which are generally counted as fats. Sphingosines and sphingolipids are also suitable as fat-like substances.

Pearlizing Waxes

If the cosmetic and/or pharmaceutical preparations are intended to be pearlescent, pearlizing waxes may be added to them. Suitable pearlizing waxes are, for example, alkylene glycol esters, especially ethylene glycol distearate; fatty acid alkanolamides, especially cocofatty acid diethanolamide; partial glycerides, especially stearic acid monoglyceride; esters of polybasic, optionally hydroxysubstituted carboxylic acids with fatty alcohols containing 6 to 22 carbon atoms, especially long-chain esters of tartaric acid; fatty compounds, such as for example fatty alcohols, fatty ketones, fatty aldehydes, fatty ethers and fatty carbonates which contain in all at least 24 carbon atoms, especially Lauron®; distearylether; fatty acids, such as stearic acid, hydroxystearic acid or behenic acid, ring opening products of C₁₂₋₂₂ olefin epoxides with C₁₂₋₂₂ fatty alcohols and/or polyols containing 2 to 15 carbon atoms and 2 to 10 hydroxyl groups and mixtures thereof.

Consistency Factors and Thickeners

The various cosmetic and/or pharmaceutical preparations are distinguished inter alia by different consistencies. Creams and soap concentrates have higher viscosities than, for example, cleansing milk or liquid soap. The viscosity of the preparations can be influenced by adding various consistency factors.

Suitable consistency factors are, above all, fatty alcohols or hydroxyfatty alcohols containing 12 to 22 and preferably 16 to 18 carbon atoms and also partial glycerides, fatty acids or hydroxyfatty acids. A combination of these substances with alkyl oligoglucosides and/or fatty acid N-methyl glucamides of the same chain length and/or polyglycerol poly-12-hydroxystearates is preferably used. Suitable thickeners are, for example, Aerosil® types (hydrophilic silicas), polysaccharides, more especially xanthan gum, guar-guar, agar-agar, alginates and tyloses, carboxymethyl cellulose and hydroxyethyl and hydroxypropyl cellulose, also relatively high molecular weight polyethylene glycol monoesters and diesters of fatty acids, polyacrylates (for example Carbopols® and Pemulen types [Goodrich]; Synthalens® [Sigma]; Keltrol types [Kelco]; Sepigel types [Seppic]; Salcare types [Allied Colloids]), polyacrylamides, polymers, polyvinyl alcohol and polyvinyl pyrrolidone. Other thickeners which have proved to be particularly effective are bentonites, for example Bentone® Gel VS-5PC (Rheox) which is a mixture of cyclopentasiloxane, Disteardimonium Hectorite and propylene carbonate. Other suitable thickeners are surfactants such as, for example, ethoxylated fatty acid glycerides, esters of fatty acids with polyols, for example pentaerythritol or trimethylol propane, narrow-range fatty alcohol ethoxylates or alkyl oligoglucosides and electrolytes, such as sodium chloride and ammonium chloride.

Superfatting Agents

In order to obtain products kind to the skin, superfatting agents may be added to the cosmetic and/or pharmaceutical preparations. Superfatting agents may be selected from such substances as, for example, lanolin and lecithin and also polyethoxylated or acylated lanolin and lecithin derivatives, polyol fatty acid esters, monoglycerides and fatty acid alkanolamides, the fatty acid alkanolamides also serving as foam stabilizers.

Stabilizers

Metal salts of fatty acids such as, for example, magnesium, aluminium and/or zinc stearate or ricinoleate may be used as stabilizers.

Polymers

Suitable cationic polymers are, for example, cationic cellulose derivatives such as, for example, the quaternized hydroxyethyl cellulose obtainable from Amerchol under the name of Polymer JR 400®, cationic starch, copolymers of diallyl ammonium salts and acrylamides, quaternized vinyl pyrrolidone/vinyl imidazole polymers such as, for example, Luviquat® (BASF), condensation products of polyglycols and amines, quaternized collagen polypeptides such as, for example, Lauryldimonium Hydroxypropyl Hydrolyzed Collagen (Lamequat® L, Grúnau), quaternized wheat polypeptides, polyethyleneimine, cationic silicone polymers such as, for example, Amodimethicone, copolymers of adipic acid and dimethylaminohydroxypropyl diethylenetriamine (Cartaretine®, Sandoz), copolymers of acrylic acid with dimethyl diallyl ammonium chloride (Merquat® 550, Chemviron), polyaminopolyamides and crosslinked water-soluble polymers thereof, cationic chitin derivatives such as, for example, quaternized chitosan, optionally in microcrystalline distribution, condensation products of dihaloalkyls, for example dibromobutane, with bis-dialkylamines, for example bis-dimethylamino-1,3-propane, cationic guar gum such as, for example, Jaguar®CBS, Jaguar®C-17, Jaguar®C-16 of Celanese, quaternized ammonium salt polymers such as, for example, Mirapol® A-15, Mirapol® AD-1, Mirapol® AZ-1 of Miranol.

Suitable anionic, zwitterionic, amphoteric and nonionic polymers are, for example, vinyl acetate/crotonic acid copolymers, vinyl pyrrolidone/vinyl acrylate copolymers, vinyl acetate/butyl maleate/isobornyl acrylate copolymers, methyl vinylether/maleic anhydride copolymers and esters thereof, uncrosslinked and polyol-crosslinked polyacrylic acids, acrylamidopropyl trimethylammonium chloride/acrylate copolymers, octylacrylamide/methyl methacrylate/tert.-butylaminoethyl methacrylate/2-hydroxypropyl methacrylate copolymers, polyvinyl pyrrolidone, vinyl pyrrolidone/vinyl acetate copolymers, vinyl pyrrolidone/dimethylaminoethyl methacrylate/vinyl caprolactam terpolymers and optionally derivatized cellulose ethers and silicones.

Silicone Compounds

Silicone compounds are preferably used in hair cleaning preparations because they have a very good conditioning effect on the hair. Accordingly, the detergent mixtures according to the invention may be used in combination with silicone compounds in hair cleaning preparations for example. Suitable silicone compounds are, for example, dimethyl polysiloxanes, methylphenyl polysiloxanes, cyclic silicones and amino-, fatty acid-, alcohol-, polyether-, epoxy-, fluorine-, glycoside- and/or alkyl-modified silicone compounds which may be both liquid and resin-like at room temperature. Other suitable silicone compounds are simethicones which are mixtures of dimethicones with an average chain length of 200 to 300 dimethylsiloxane units and hydrogenated silicates.

Film Formers

Film formers lead to a further improved sensory profile in combination with the detergent mixtures according to the invention. Typical film formers are, for example, chitosan, microcrystalline chitosan, quaternized chitosan, polyvinyl pyrrolidone, vinyl pyrrolidone/vinyl acetate copolymers, polymers of the acrylic acid series, quaternary cellulose derivatives, collagen, hyaluronic acid and salts thereof and similar compounds.

Antidandruff Agents

The detergent mixtures according to the invention may be used in hair shampoos together with anti-dandruff agents. Suitable antidandruff agents are piroctone olamine (1-hydroxy-4-methyl-6-(2,4,4-trimethylpentyl)-2-(1H)-pyridinone monoethanolamine salt), Baypival® (climbazole), Ketoconazol® (4-acetyl-1-{4-[2-(2,4-dichlorophenyl) r-2-(1H-imidazol-1-ylmethyl)-1,3-dioxylan-c-4-ylmethoxyphenyl}-piperazine, ketoconazole, elubiol, selenium disulfide, colloidal sulfur, sulfur polyethylene glycol sorbitan monooleate, sulfur ricinol polyethoxylate, sulfur tar distillate, salicylic acid (or in combination with hexachlorophene), undecylenic acid, monoethanolamide sulfosuccinate Na salt, Lamepon® UD (protein/undecylenic acid condensate), zinc pyrithione, aluminium pyrithione and magnesium pyrithione/dipyrithione magnesium sulfate.

Swelling Agents

Suitable swelling agents for aqueous phases are montmorillonites, clay minerals, Pemulen and alkyl-modified Carbopol types (Goodrich).

Perfume Oils and Aromas

Perfume oils or aromas may be added to the cosmetic and/or pharmaceutical preparations containing the detergent mixtures according to the invention. Suitable perfume oils are mixtures of natural and synthetic perfumes. Natural perfumes include the extracts of blossoms (lily, lavender, rose, jasmine, neroli, ylang-ylang), stems and leaves (geranium, patchouli, petitgrain), fruits (anise, coriander, caraway, juniper), fruit peel (bergamot, lemon, orange), roots (nutmeg, angelica, celery, cardamom, costus, iris, calmus), woods (pinewood, sandalwood, guaiac wood, cedarwood, rosewood), herbs and grasses (tarragon, lemon grass, sage, thyme), needles and branches (spruce, fir, pine, dwarf pine), resins and balsams (galbanum, elemi, benzoin, myrrh, olibanum, opoponax). Animal raw materials, for example civet and beaver, may also be used. Typical synthetic perfume compounds are products of the ester, ether, aldehyde, ketone, alcohol and hydrocarbon type. Examples of perfume compounds of the ester type are benzyl acetate, phenoxyethyl isobutyrate, p-tert.butyl cyclohexylacetate, linalyl acetate, dimethyl benzyl carbinyl acetate, phenyl ethyl acetate, linalyl benzoate, benzyl formate, ethylmethyl phenyl glycinate, allyl cyclohexyl propionate, styrallyl propionate and benzyl salicylate. Ethers include, for example, benzyl ethyl ether while aldehydes include, for example, the linear alkanals containing 8 to 18 carbon atoms, citral, citronellal, citronellyloxyacetaldehyde, cyclamen aldehyde, hydroxy-citronellal, lilial and bourgeonal. Examples of suitable ketones are the ionones, α-isomethylionone and methyl cedryl ketone. Suitable alcohols are anethol, citronellol, eugenol, isoeugenol, geraniol, linalool, phenylethyl alcohol and terpineol. The hydrocarbons mainly include the terpenes and balsams. However, it is preferred to use mixtures of different perfume compounds which, together, produce an agreeable perfume. Other suitable perfume oils are essential oils of relatively low volatility which are mostly used as aroma components. Examples are sage oil, camomile oil, clove oil, melissa oil, mint oil, cinnamon leaf oil, lime-blossom oil, juniper berry oil, vetiver oil, olibanum oil, galbanum oil, ladanum oil and lavendin oil. The following are preferably used either individually or in the form of mixtures: bergamot oil, dihydromyrcenol, lilial, lyral, citronellol, phenylethyl alcohol, α-hexylcinnamaldehyde, geraniol, benzyl acetone, cyclamen aldehyde, linalool, Boisambrene Forte, Ambroxan, indole, hedione, sandelice, citrus oil, mandarin oil, orange oil, allylamyl glycolate, cyclovertal, lavendin oil, clary oil, β-damascone, geranium oil bourbon, cyclohexyl salicylate, Vertofix Coeur, Iso-E-Super, Fixolide NP, evernyl, iraldein gamma, phenylacetic acid, geranyl acetate, benzyl acetate, rose oxide, romillat, irotyl and floramat.

Suitable aromas are, for example, peppermint oil, spearmint oil, aniseed oil, Japanese anise oil, caraway oil, eucalyptus oil, fennel oil, citrus oil, wintergreen oil, clove oil, menthol and the like.

Dyes

Suitable dyes are any of the substances suitable and approved for cosmetic purposes. Examples include cochineal red A (C.I. 16255), patent blue V (C.I. 42051), indigotin (C.I. 73015), chlorophyllin (C.I. 75810), quinoline yellow (C.I. 47005), titanium dioxide (C.I. 77891), indanthrene blue RS (C.I. 69800) and madder lake (C.I. 58000). Luminol may also be present as a luminescent dye. These dyes are normally used in concentrations of 0.001 to 0.1% by weight, based on the mixture as a whole.

The total percentage content of auxiliaries and additives may be from 1 to 50% by weight and is preferably from 5 to 40% by weight, based on the particular preparations. The preparations may be produced by standard hot or cold processes and are preferably produced by the phase inversion temperature method.

### EXAMPLES

### Example 1

1,000 kg of a 56% aqueous wheat protein hydrolyzate with a molecular weight of 625 D and 265.0 kg of sodium glutamate monohydrate were introduced into a stirred reactor and stirred at 30° C. until a clear solution was obtained. A pH of 9.5 was then adjusted while cooling by addition of 50% sodium hydroxide solution. 382.0 kg of fatty acid chloride were then added with vigorous stirring so that the temperature did not exceed 60° C. At the same time, the pH was kept at 9.4 to 10 (as measured at 40° C.) by addition of 50% sodium hydroxide solution, the total consumption of 50% sodium hydroxide solution amounting to 304.0 kg. After addition of 30.0 kg of 1,2-propylene glycol, the product was adjusted with citric acid to a pH of 6.7 and to a water content of ca. 52%.

### Example 2

1,000 kg of a 56% aqueous wheat protein hydrolyzate with a molecular weight of 625 D, 20.0 kg of isopropanol and 265.0 kg of sodium glutamate monohydrate were introduced into a stirred reactor and stirred at 30° C. until a clear solution was obtained. A pH of 9.5 was then adjusted while cooling by addition of 50% sodium hydroxide solution. 382.0 kg of fatty acid chloride were then added with vigorous stirring so that the temperature did not exceed 60° C. At the same time, the pH was kept at 9.4 to 10 (as measured at 50° C.) by addition of 50% sodium hydroxide solution, the total consumption of 50% sodium hydroxide solution amounting to 304.0 kg. The product was then adjusted with citric acid to a pH of 6.7 and to a water content of ca. 51%.

### Example 3

615 kg of a 30% aqueous wheat protein hydrolyzate with a molecular weight of 625 D and 67.5 kg of 4-hydroxyproline were introduced into a stirred reactor and stirred at 30° C. until a clear solution was obtained. A pH of 9.5 was then adjusted while cooling by addition of 50% sodium hydroxide solution. 125.7 kg of fatty acid chloride were then added with vigorous stirring so that the temperature did not exceed 60° C. At the same time, the pH was kept at 9.4 to 10 (as measured at 50° C.) by addition of 130 kg of 50% sodium hydroxide solution. The product was then adjusted with citric acid to a pH of 6.7 and to a water content of ca. 52%.

### Example 4

615 kg of a 30% aqueous wheat protein hydrolyzate with a molecular weight of 625 D and 67.5 kg of 4-hydroxyproline were introduced into a stirred reactor and stirred at 30° C. until a clear solution was obtained. A pH of 9.5 was then adjusted while cooling by addition of 50% sodium hydroxide solution. 125.7 kg of fatty acid chloride were then added with vigorous stirring so that the temperature did not exceed 60° C. At the same time, the pH was kept at 9.4 to 10 (as measured at 50° C.) by addition of 180 kg of 50% potassium hydroxide solution. The product was then adjusted with citric acid to a pH of 6.7 and to a water content of ca. 47%.

### Example 5

615 kg of a 30% aqueous wheat protein hydrolyzate with a molecular weight of 625 D, 20.0 kg of isopropanol and 67.5 kg of 5-pyrroldone-2-carboxylic acid were introduced into a stirred reactor and stirred at 30° C. until a clear solution was obtained. A pH of 9.5 was then adjusted while cooling by addition of 50% sodium hydroxide solution. 125.7 kg of fatty acid chloride were then added with vigorous stirring so that the temperature did not exceed 60° C. At the same time, the pH was kept at 9.4 to 10 (as measured at 50° C.) by addition of 130 kg of 50% sodium hydroxide solution. The product was then adjusted with citric acid to a pH of 6.7 and to a water content of ca. 56%.

### Example 6

The mild detergent mixtures produced in Examples 1 to 5 have the following compositions (quantities in % by weight).

| | Examples | | | | |
|---|---|---|---|---|---|
| Ingredients | 1 | 2 | 3 | 4 | 5 |
| Protein condensate (Na or Na/K salt) | 18.7 | 19.4 | 18.9 | 19.1 | 18.3 |
| Protein hydrolyzate (Na or Na/K salt) | 4.5 | 4.7 | 4.5 | 4.5 | 4.5 |
| Acylated amino acid (Na/K salt) | 8.4 | 9.6 | 9.2 | 10.1 | 5.0 |
| Amino acid (Na/K salt) | 3.9 | 4.3 | 3.6 | 4.0 | 4.5 |
| Citric acid (Na/K salt) | 4.7 | 4.4 | 4.7 | 6.1 | 4.6 |
| Fatty acid (Na/K salt) | 2.5 | 2.2 | 2.5 | 2.7 | 2.5 |
| NaCl or Na/KCl | 4.2 | 4.5 | 4.2 | 6.2 | 4.5 |
| Isopropanol | — | 0.7 | — | — | — |
| 1,2-Propylene glycol | 1.1 | — | — | — | — |
| Water | 52.0 | 50.2 | 52.4 | 47.3 | 56.1 |

### Example 7

The quantities by weight of the protein condensate and protein hydrolyzate in the detergent mixture were determined as follows:
a) The molar quantity of protein condensate is the molar quantity of fatty acid chloride used in the acylation minus the molar quantity of fatty acid (calculated from the quantity by weight determined by gas chromatography after silylation) minus the molar quantity of acylated amino acid (calculated from the chromatographically determined quantity by weight).
b) Accordingly, the molar quantity of protein hydrolyzate in the detergent mixture is the molar quantity of protein hydrolyzate used minus the molar quantity of protein condensate determined as in a).
c) The quantities by weight of protein condensate and protein hydrolyzate in the detergent mixture are the molar quantities multiplied by the molecular weight of the protein condensate and protein hydrolyzate.

1-13. (canceled)

14. A detergent mixture comprising:
(a) 10 to 30% by weight of a protein fatty acid condensate;
(b) 1 to 12% by weight of a protein hydrolyzate;
(c) 3 to 20% by weight of an acylated amino acid;
(d) 1 to 12% by weight of an amino acid; and
(e) 0 to 3% by weight of a preservative.

15. The detergent mixture as claimed in claim 14, additionally comprising
(f) 0.1 to 10% by weight of a neutralizing agent.

16. The detergent mixture as claimed in claim 14, additionally comprising
(g) 0.1 to 15% by weight of a member selected from the group consisting of sodium chloride, potassium chloride and mixtures thereof.

17. The detergent mixture of claim 14, additionally comprising (h) 0.1 to 15% by weight of at least one solvent selected from the group consisting of ethanol, isopropanol, 1,2-propylene glycol, trimethyl hexanol, glycerol, ethylene glycol, 2-methylpropane-1,3-diol, 1,3-propylene glycol, dipropylene glycol, 1,3-butylene glycol, butane-1,2-diol, butane-1,4-diol, isopentyl diol, sorbitol, xylitol, mannitol, erythritol, pentaerythritol, 1-methoxy-2-propan-1,2-ol, 2-methoxy ethanol, 2-ethoxy ethanol, 2-propoxy ethanol, 2-isopropoxy ethanol, 2-butoxy ethanol, 1-methoxy-2-propanol, 1-ethoxy-2-propanol, 1-propoxy-2-propanol, 1-isopropoxy-2-propanol, 1-butoxy-2-propanol, 1-isobutoxy-2-propanol, methoxy isopropanol, diethylene glycol monomethyl ether, diethylene glycol monoethyl ether, diethylene glycol monopropyl ether, diethylene glycol monoisopropyl ether, diethylene glycol monobutyl ether, triethylene glycol monomethyl ether, triethylene glycol monoethyl ether, triethylene glycol monopropyl ether, triethylene glycol monoisopropyl ether, triethylene glycol monobutyl ether, dipropylene glycol monomethyl ether, dipropylene glycol monoethyl ether, dipropylene glycol monopropyl ether, dipropylene glycol monoisopropyl ether, dipropylene glycol monobutyl ether and hexylene glycol.

18. The detergent mixture as claimed in claim 14, wherein, components (a) to (d) and (f), independently of one another, are present in the form of their alkali metal, alkaline earth metal or ammonium salts.

19. The detergent mixture of claim 14, wherein, components (a) to (d) and (f) independently of one another comprise ammonium salts, the amines being selected from the group consisting of ammonia, triethanolamine, monoethanolamine, monoisopropanolamine, triisopropylamine, 2-aminobutanol, aminoethyl propanediol. aminomethyl propanol, aminomethyl propanediol, 2-amino-2-hydroxymethyl propane-1,3-diol and mixtures thereof.

20. The detergent mixture of claim 14 comprising a water content of 20 to 60% by weight.

21. The detergent mixture of claim 14, wherein, the acyl groups of the acylamino acid and the protein fatty acid condensate are derived from the same acid composition and have an alkyl chain length of 8 to 18 carbon atoms.

22. The detergent mixture of claim 14, wherein, the acyl components of the acylamino acid and the protein fatty acid condensate comprise the same acid residues of coconut oil fatty acids.

23. The detergent mixture of claim 14, wherein, component (d) comprises: a compound selected from the group consisting of glutamic acid, sarcosine, lysine, proline, 4-hydroxyproline and mixtures thereof.

24. The detergent mixture of claim 14, wherein, component (b) comprises: a wheat protein hydrolyzate with a molecular weight of 300 to 1,200.

25. The detergent mixture of claim 14, wherein, component (b) comprises: a soya protein hydrolyzate with a molecular weight of 300 to 1,200.

26. The detergent mixture of claim 14, wherein, component (b) comprises: a collagen protein hydrolyzate with a molecular weight of 300 to 1,500.

27. The detergent mixture of claim 24 further comprising 1% to 50% by weight of auxiliaries and additives.

28. The detergent mixture of claim 20 further comprising 1% to 50% by weight of auxiliaries and additions.

29. The detergent mixture of claim 16 additionally comprising (h) 0.1 to 15% by weight of at least one solvent selected from the group consisting of ethanol, isopropanol, 1,2-propylene glycol, trimethyl hexanol, glycerol, ethylene glycol, 2-methylpropane-1,3-diol, 1,3-propylene glycol, dipropylene glycol, 1,3-butylene glycol, butane-1,2-diol, butane-1,4-diol, isopentyl diol, sorbitol, xylitol, mannitol, erythritol, pentaerythritol, 1-methoxy-2-propan-1,2-ol, 2-methoxy ethanol, 2-ethoxy ethanol, 2-propoxy ethanol, 2-isopropoxy ethanol, 2-butoxy ethanol, 1-methoxy-2-propanol, 1-ethoxy-2-propanol, 1-propoxy-2-propanol, 1-isopropoxy-2-propanol, 1-butoxy-2-propanol, 1-isobutoxy-2-propanol, methoxy isopropanol, diethylene glycol monomethyl ether, diethylene glycol monoethyl ether, diethylene glycol monopropyl ether, diethylene glycol monoisopropyl ether, diethylene glycol monobutyl ether, triethylene glycol monomethyl ether, triethylene glycol monoethyl ether, triethylene glycol monopropyl ether, triethylene glycol monoisopropyl ether, triethylene glycol monobutyl ether, dipropylene glycol monomethyl ether, dipropylene glycol monoethyl ether, dipropylene glycol monopropyl ether, dipropylene glycol monoisopropyl ether, dipropylene glycol monobutyl ether and hexylene glycol.

30. The detergent mixture of claim 14 having a pH value in a range of 6.5to 8.

31. The detergent mixture as claimed in claim 15, additionally comprising (g) 0.1 to 15% by weight of a member selected from the group consisting of sodium chloride, potassium chloride and mixtures thereof.

32. The detergent mixture of claim 15, additionally comprising (h) 0.1 to 15% by weight of at least one solvent selected from the group consisting of ethanol, isopropanol, 1,2-propylene glycol, trimethyl hexanol, glycerol, ethylene glycol, 2-methylpropane-1,3-diol, 1,3-propylene glycol, dipropylene glycol, 1,3-butylene glycol, butane-1,2-diol, butane-1,4-diol, isopentyl diol, sorbitol, xylitol, mannitol, erythritol, pentaerythritol, 1-methoxy-2-propan-1,2-ol, 2-methoxy ethanol, 2-ethoxy ethanol, 2-propoxy ethanol, 2-isopropoxy ethanol, 2-butoxy ethanol, 1-methoxy-2-propanol, 1-ethoxy-2-propanol, 1-propoxy-2-propanol, 1-isopropoxy-2-propanol, 1-butoxy-2-propanol, 1-isobutoxy-2-propanol, methoxy isopropanol, diethylene glycol monomethyl ether, diethylene glycol monoethyl ether, diethylene glycol monopropyl ether, diethylene glycol monoisopropyl ether, diethylene glycol monobutyl ether, triethylene glycol monomethyl ether, triethylene glycol monoethyl ether, triethylene glycol monopropyl ether, triethylene glycol monoisopropyl ether, triethylene glycol monobutyl ether, dipropylene glycol monomethyl ether, dipropylene glycol monoethyl ether, dipropylene glycol monopropyl ether, dipropylene glycol monoisopropyl ether, dipropylene glycol monobutyl ether and hexylene glycol.

33. The detergent mixture as claimed in claim 15, wherein, components (a) to (d) and (f), independently of one another, are present in the form of their alkali metal, alkaline earth metal or ammonium salts.

34. The detergent mixture of claim 15, wherein, components (a) to (d) and (f) independently of one another comprise ammonium salts, the amines being selected from the group consisting of ammonia, triethanolamine, monoethanolamine, monoisopropanolamine, triisopropylamine, 2-aminobutanol, aminoethyl propanediol. aminomethyl propanol, aminomethyl propanediol, 2-amino-2-hydroxymethyl propane-1,3-diol and mixtures thereof.

35. The detergent mixture of claim 15 comprising a water content of 20 to 60% by weight.

36. The detergent mixture of claim 15, wherein, the acyl groups of the acylamino acid and the protein fatty acid condensate are derived from the same acid composition and have an alkyl chain length of 8 to 18 carbon atoms.

37. The detergent mixture of claim 15, wherein, the acyl components of the acylamino acid and the protein fatty acid condensate comprise the same acid residues of coconut oil fatty acids.

38. The detergent mixture of claim 15, wherein, component (d) comprises: a compound selected from the group consisting of glutamic acid, sarcosine, lysine, proline, 4-hydroxyproline and mixtures thereof.

39. The detergent mixture of claim 15, wherein, component (b) comprises: a wheat protein hydrolyzate with a molecular weight of 300 to 1,200.

40. The detergent mixture of claim 15 having a pH value in a range of 6.5 to 8.
